(19) United States
(12) Patent Application Publication
(10) Pub. No.: US 2026/0138611 A1
(43) Pub. Date: May 21, 2026

(54) DRIVER ASSISTANCE APPARATUS, VEHICLE, AND DRIVER ASSISTANCE METHOD

(71) Applicant: SUBARU CORPORATION, Tokyo (JP)

(72) Inventor: Ikuo GOTO, Tokyo (JP)

(21) Appl. No.: 19/427,488

(22) Filed: Dec. 19, 2025

Related U.S. Application Data
(63) Continuation of application No. PCT/JP2023/027562, filed on Jul. 27, 2023.

(51) Int. Cl. B60W 30/18; B60W 60/00

(52) U.S. Cl. CPC B60W 30/18163; B60W 60/0015; B60W 2554/4046; B60W 2554/802

(57) ABSTRACT

A driver assistance apparatus includes a processor configured to estimate a likelihood of a second vehicle entering an inter-vehicular space ahead of a first vehicle traveling on a first lane by making a lane change from a second lane. The processor is configured to: acquire position data on each of third vehicles traveling on the first lane and size data on the inter-vehicular space ahead of the first vehicle; determine whether the inter-vehicular space is an entry available space, based on the position data and the size data; and when the inter-vehicular space is the entry available space, estimates a likelihood of the second vehicle entering the entry available space, based on a length of a waiting time estimated to be spent by the second vehicle before making the lane change or a length of a measurement time having a predetermined correlation with the length of the waiting time.

### CROSS REFERENCE TO RELATED APPLICATIONS

This application is continuation of International Application No. PCT/JP2023/027562, filed on Jul. 27, 2023, the entire contents of which are hereby incorporated by reference.

### BACKGROUND

The disclosure relates to a driver assistance apparatus to be applied to a vehicle, a vehicle, and a driver assistance method.

Recently, development has been made on automated driving control technology that causes a vehicle such as an automobile to automatically travel without relying on driver's driving operations. Further, various driver assistance apparatuses that perform various kinds of control to assist driver's driving operation using the automated driving control technology have been proposed and put into practical use. Such technology regarding the driver assistance apparatus is disclosed in, for example, International Publication No. WO 2020/161512 and Japanese Unexamined Patent Application Publication (JP-A) Nos. 2003-288691, H5-517099, 2020-160899, and 2021-060906.

### SUMMARY

An aspect of the disclosure provides a driver assistance apparatus including a processor. The processor is configured to estimate a likelihood of a second vehicle entering an inter-vehicular space ahead of a first vehicle traveling on a first lane by making a lane change from a second lane adjacent to the first lane. The processor is configured to: acquire position data on each of third vehicles traveling on the first lane and size data on the inter-vehicular space ahead of the first vehicle, the third vehicles including the first vehicle; make a determination, based on the position data and the size data, as to whether the inter-vehicular space is an entry available space which the second vehicle is allowed to enter by making a lane change; and when the inter-vehicular space is the entry available space, estimate a likelihood of the second vehicle entering the entry available space, based on a length of a waiting time estimated to be spent by the second vehicle before starting to make the lane change to the entry available space or a length of a measurement time having a predetermined correlation with the length of the waiting time.

An aspect of the disclosure provides a vehicle including a processor. The processor is configured to estimate a likelihood of a second vehicle entering an inter-vehicular space ahead of a first vehicle traveling on a first lane by making a lane change from a second lane adjacent to the first lane. The processor is configured to: acquire position data on each of third vehicles including the first vehicle and traveling on the first lane and size data on the inter-vehicular space ahead of the first vehicle; make a determination, based on the position data and the size data, as to whether the inter-vehicular space is an entry available space which the second vehicle is allowed to enter by making the lane change; and when the inter-vehicular space is the entry available space, estimate a likelihood of the second vehicle entering the entry available space, based on a length of a waiting time estimated to be spent by the second vehicle before starting to make the lane change to the entry available space or a length of a measurement time having a predetermined correlation with the length of the waiting time.

An aspect of the disclosure provides a driver assistance method of estimating a likelihood of a second vehicle entering an inter-vehicular space ahead of a first vehicle traveling on a first lane by making a lane change from a second lane adjacent to the first lane. The method includes: acquiring, with integrated circuitry, position data on each of third vehicles including the first vehicle and traveling on the first lane and size data on the inter-vehicular space ahead of the first vehicle via a communication line; determining, with the integrated circuitry, whether the inter-vehicular space is an entry available space which the second vehicle is allowed to enter by making the lane change, based on the position data and the size data; and when the inter-vehicular space is the entry available space, estimating, with the integrated circuitry, a likelihood of the second vehicle entering the entry available space, based on a length of a waiting time estimated to be spent by the second vehicle before starting to make the lane change to the entry available space or a length of a measurement time having a predetermined correlation with the length of the waiting time.

An aspect of the disclosure provides a driver assistance apparatus including a processor. The processor is configured to: estimate a likelihood of a first vehicle entering a right-side lane or a left-side lane by making a lane change from a center lane; and estimate a likelihood of the first vehicle entering an inter-vehicular space ahead of a third vehicle traveling on the right-side lane or the left-side lane from the center lane. The center lane, the right-side lane, and the left-side lane have respective traveling directions identical to each other. The processor is configured to: acquire data on number of a second vehicle traveling ahead of the first vehicle on the right-side lane or the left-side lane; estimate a likelihood of the first vehicle entering the right-side lane or the left-side lane, based on the data on the number of the second vehicle; acquire position data on each of fourth vehicles including the third vehicle and traveling on the right-side lane or the left-side lane on which the third vehicle travels, and size data on the inter-vehicular space ahead of the third vehicle;, make a determination, based on the position data and the size data, as to whether the inter-vehicular space is an entry available space which the second vehicle is allowed to enter by making a lane change; and when the inter-vehicular space is the entry available space, estimate a likelihood of the second vehicle entering the entry available space, based on a length of a waiting time estimated to be spent by the second vehicle before starting to make the lane change to the entry available space or a length of a measurement time having a predetermined correlation with the length of the waiting time.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to explain the principles of the disclosure.

FIG. 1 is a block diagram schematically illustrating a configuration example of a traveling control system according to one example embodiment of the disclosure.

FIG. 2 is a flowchart of an exemplary process performed by the traveling control system illustrated in FIG. 1 to estimate a lane change.

FIG. 3 is a diagram illustrating an exemplary traffic situation in Steps S101 to S105 in FIG. 2.

FIG. 4 is a diagram illustrating an exemplary traffic situation in Step S106 to S108 in FIG. 2.

FIG. 5 is a diagram illustrating an exemplary traffic situation in Step S109 in FIG. 2.

FIG. 6 is a flowchart of a modification example of the process performed by the traveling control system illustrated in FIG. 1 to estimate a lane change.

FIG. 7 is a flowchart of the process of estimating a lane change subsequent to the flowchart in FIG. 6.

FIG. 8 is a diagram illustrating an exemplary traffic situation in Steps S201 to S205 in FIG. 6.

FIG. 9 is a diagram illustrating an exemplary traffic situation in Steps S206 to S208 in FIG. 7.

FIG. 10 is a diagram illustrating an exemplary traffic situation in Step S209 in FIG. 7

FIG. 11 is a diagram illustrating an exemplary virtual traffic situation.

FIG. 12 is a diagram illustrating an exemplary virtual traffic situation subsequent to the diagram in FIG. 11.

### DETAILED DESCRIPTION

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 1. Background

Recently, development has been made on automated driving control technology that causes a vehicle such as an automobile to automatically travel without relying on driver's driving operations. Further, various driver assistance apparatuses that perform various kinds of control to assist driver's driving operation using the automated driving control technology have been proposed and put into practical use.

Some existing driver assistance apparatuses are provided with a lane-keep traveling control functionality that causes a vehicle to keep traveling along a current traveling lane, based on various kinds of data acquired by various kinds of sensor devices that constantly detect a surrounding environment of the vehicle. When an own vehicle automatically travels using the lane-keep traveling control functionality, another vehicle traveling on an adjacent lane can make a lane change to a space in front of the own vehicle. At this time, the own vehicle has can contact the other vehicle making the lane change, depending on the timing of the lane change. To safely avoid such a risk, it is important to predict whether the other vehicle traveling on the adjacent lane intends to make a lane change, and to perform traveling control based on the prediction, for example. Some techniques of predicting a lane change are disclosed in International Publication No. WO 2020/161512 and JP-A Nos. 2003-288691, H 5-517099, 2020-160899, and 2021-060906.

In the techniques disclosed in International Publication No. WO 2020/161512 and JP-A No. 2003-288691, it is predicted that the likelihood of a lane change of the other vehicle traveling on the adjacent lane becomes greater as an inter-vehicular space immediately in front of the own vehicle becomes longer. However, the other vehicle traveling on the adjacent lane will not necessarily make a lane change even when the inter-vehicular space immediately in front of the own vehicle becomes longer. Thus, the existing techniques can cause frequent execution of unnecessary traveling control against a lane change.

In the technique disclosed in JP-A No. H5-517099, it is predicted that the likelihood of a lane change of the other vehicle traveling on the adjacent lane is great when the own vehicle and the other vehicle traveling on the adjacent lane have traveled at substantially the same speed for a predetermined time. However, the other vehicle traveling on the adjacent lane will not necessarily make a lane change even when the own vehicle and the other vehicle traveling on the adjacent lane have traveled at substantially the same speed for the predetermined time. Thus, the existing technique can cause frequent execution of unnecessary traveling control against a lane change.

In the technique disclosed in JP-A No. 2020-160899, it is predicted that the likelihood of a lane change of the other vehicle is great when the other vehicle has stopped traveling on the adjacent lane for a predetermined time due to traffic congestion on the adjacent lane. However, this technique is designed on the assumption that the other vehicle has stopped due to the traffic congestion on the adjacent lane and is thus not designed to predict the likelihood of a lane change of the other vehicle traveling on the adjacent lane.

In the technique disclosed in JP-A No. 2021-060906, the likelihood of a lane change of a target vehicle is predicted based on the number of vehicles traveling behind the target vehicle on two lanes adjacent to a lane on which the target vehicle travels. However, it is difficult for a driver who drives the target vehicle to recognize the number of vehicles traveling behind the target vehicle when making a lane change, and it is unclear how far the number of the vehicles present behind the target vehicle actually relates to the likelihood of a lane change. Thus, the existing technique can cause frequent execution of unnecessary traveling control against a lane change.

As described above, the existing techniques can cause frequent execution of unnecessary traveling control against a lane change. To address such a problem, the inventor of the disclosure conceived, through vigorous researches, the technology of predicting the likelihood of a lane change, based on a traffic situation highly correlated with a driver's psychological state of wanting to make a lane change. The background of the technology newly conceived by the inventor of the disclosure will now be described by way of exemplary virtual traffic situations.

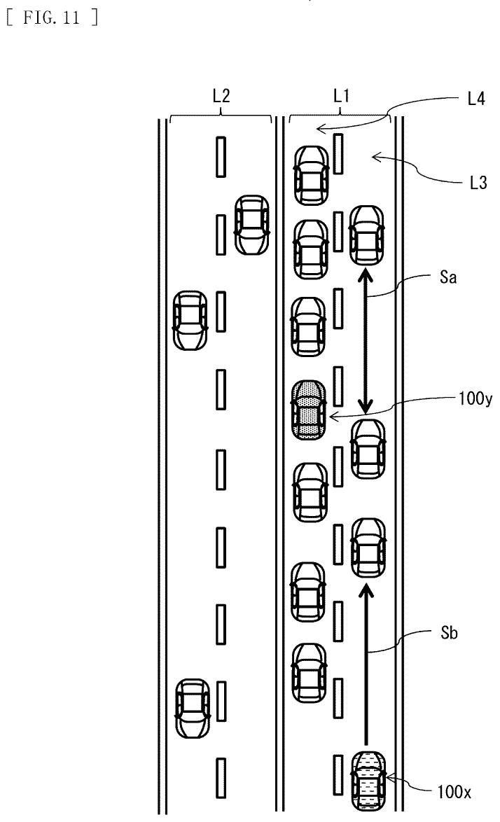

FIG. 11 illustrates an exemplary virtual traffic situation. In the example illustrated in FIG. 11, a vehicle (hereinafter referred to as own vehicle) 100x may travel on a road with two lanes each way. The road may include a traveling lane L1 on which the vehicle 100x travels, and an oncoming lane L2 provided along the traveling lane L1 with a center line provided therebetween. The traveling lane L1 may include two traveling lanes L3 and L4. The traveling lane L3 may be what is called a passing lane. The traveling lane L4 may be provided between the center line and the traveling lane L3. The vehicle 100x may travel on the traveling lane L3, and a vehicle 100y, which is predicted to make a lane change from the traveling lane L4 to the traveling lane L3, may travel on the traveling lane L4. There may be much traffic on the traveling lane L4, while there may not be much traffic on the traveling lane L3. Thus, it may be predicted that a driver who drives the vehicle 100y is in the psychological state of wanting to make a lane change from the traveling lane L4 to the traveling lane L3.

When the vehicle 100y has still traveled on the traveling lane L4 after failing to make a lane change to an inter-vehicular space Sa available for the lane change, the driver who drives the vehicle 100y is to wait on the traveling lane L4 for the coming of a next inter-vehicular space Sb available for the lane. In the waiting time, the driver who drives the vehicle 100y is to continue to pay attention to the traveling lane L3 to recognize the coming of the next inter-vehicular space Sb at an early timing.

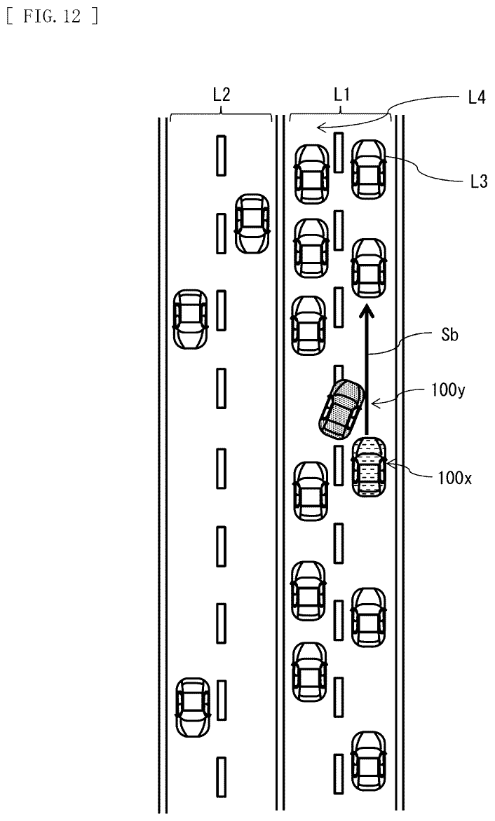

As the waiting time during which the vehicle 100y continues to travel on the traveling lane L3 waiting for the coming of the next inter-vehicular space Sb is prolonged, the driver who drives the vehicle 100y can get more irritated and pay less attention to the surrounding traffic situation. As a result, the driver who drives the vehicle 100y can make erroneous recognition and make a lane change reflexively upon recognizing the next inter-vehicular space Sb. Such a reflexive lane change can pose a risk to vehicles traveling on the traveling lane L3. For example, when the vehicle (own vehicle) 100x is traveling at a rear end of the inter-vehicular space Sb as illustrated in FIG. 12, the vehicle 100y can come into contact with the vehicle 100x. The inventor of the disclosure focused on the length of the waiting time highly correlated with the psychological state of the driver easy to make the erroneous recognition, and conceived the technology of predicting the likelihood of a lane change, based on the length of the waiting time. A traveling control system that makes it possible to implement the technology will be described in detail below.

### 2. Example Embodiments

### Configuration Example

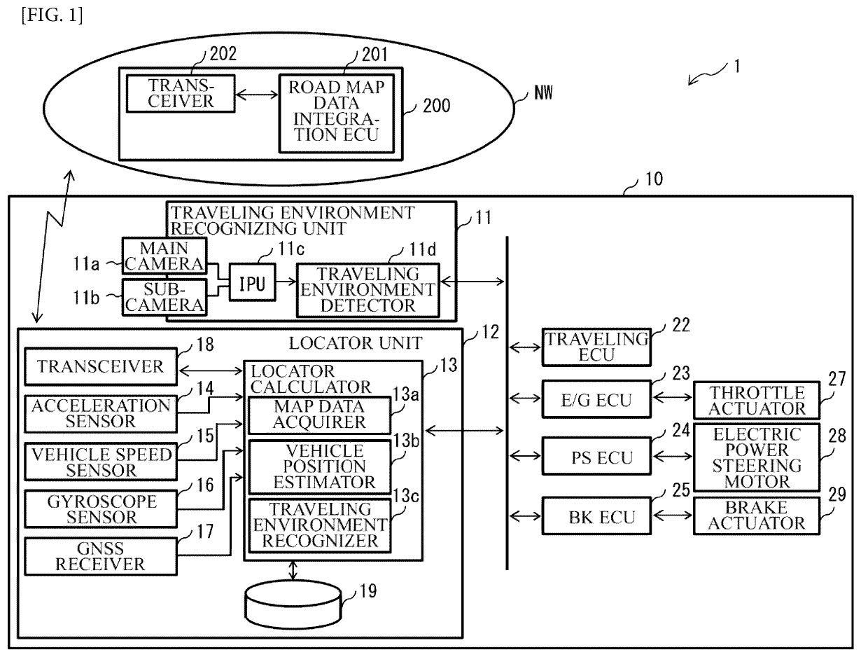

FIG. 1 schematically illustrates a configuration example of a traveling control system 1 according to an example embodiment of the disclosure. Referring to FIG. 1, for example, the traveling control system 1 may include traveling control apparatuses 10 mounted in respective vehicles, and a control apparatus 200 provided in a network environment NW to which the traveling control apparatuses 10 are coupled via wireless communication. In one embodiment, the traveling control apparatus 10 may serve as a “driver assistance apparatus”.

The control apparatus 200 may update road map data by integrating road map data items sequentially transmitted from the traveling control apparatuses 10 of the respective vehicles and may transmit the updated road map data to each of the vehicles. The control apparatus 200 may include, for example, a road map data integration ECU 201 and a transceiver 202.

The road map data integration ECU 201 may integrate the road map data items collected from the vehicles via the transceiver 202 to update the road map data on the surrounding environment in which the vehicles are traveling, as necessary. In some embodiments, the road map data may be a dynamic map including road data and traffic data. The road data may include static data and quasi-static data, and the traffic data may include dynamic data and quasi-dynamic data.

In some embodiments, the static data may include data on roads, data on structures on roads, data on lanes, data on road surfaces, and data on permanent regulations that are to be updated every month or more frequently. In some embodiments, the quasi-static data may include data on traffic regulations, data on road works or events, data on wide-area weather, and data on traffic congestion prediction that are to be updated every hour or more frequently. In some embodiments, the quasi-static data may include data on actual traffic congestion or traveling regulations at an observation time point, data on fallen objects or obstructs, data on temporary traveling blockages, data on actual accidents, and data on narrow-area weather that are to be updated every minute or more frequently. In some embodiments, the dynamic data may include data to be exchanged between mobile bodies, data on signals currently indicated, data on pedestrians or bicycles in intersections, and data on vehicles traveling on roads that are to be updated every second or more frequently. Such road map data may be stored and updated until the next road map data item is received from each vehicle, and the updated road map data may be transmitted to each vehicle via the transceiver 202, as appropriate.

The traveling control apparatus 10 may include a traveling environment recognizing unit 11 and a locator unit 12 as units that recognize a traveling environment surrounding the corresponding vehicle. The traveling control apparatus 10 may further include a traveling control unit (hereinafter referred to as traveling ECU) 22, an engine control unit (hereinafter referred to as E/G ECU) 23, a power steering control unit (hereinafter referred to as PS ECU) 24, and a brake control unit (hereinafter referred to as BK ECU) 25. These control units 22 to 25 may be coupled to the traveling environment recognizing unit 11 and the locator unit 12 via an in-vehicle communication line such as a controller area network (CAN).

The traveling ECU 22 may control the vehicle in accordance with driving modes. The driving modes may include, for example, a manual driving mode and a traveling control mode. In the manual driving mode, a steering wheel may be steered by a driver who drives the vehicle. In the manual driving mode, the own vehicle may be caused to travel in accordance with a driver's operation such as a steering operation, an accelerating operation, or a braking operation. In the traveling control mode, the driver may be assisted in making driving operations to secure the safety of pedestrians or other vehicles present around the own vehicle. For example, in a case where a signal of a traffic light at an intersection changes from green via yellow to red when the own vehicle traveling in the traveling control mode comes closer to the intersection, the traveling ECU 22 may control the own vehicle to stop at or before a stop line provided near the intersection. The process in the traveling control mode will be described in detail later.

A throttle actuator 27 may be coupled to an output side of the E/G ECU 23. The throttle actuator 27 may open and close a throttle value of an electronically controlled throttle provided on a throttle body of the engine. The throttle actuator 27 may adjust an intake air flow amount by opening and closing the throttle valve in accordance with drive signals from the E/G ECU 23 to thereby generate a desired engine output.

An electric power steering motor 28 may be coupled to an output side of the PS ECU 24. Using a motor rotation force, the electric power steering motor 28 may apply steering torque to a steering mechanism. In the automated driving, the electric power steering motor 28 may execute lane-keep traveling control that causes the own vehicle to keep traveling on a current traveling lane by causing the electric power steering motor 28 to operate in accordance with drive signals from the PS ECU 24, and lane-change control that causes the own vehicle to move to an adjacent lane to overtake and pass another vehicle.

A brake actuator 29 may be coupled to an output side of the BK ECU 25. The brake actuator 29 may adjust a brake liquid pressure to be supplied to a brake wheel cylinder provide at each wheel. When the brake actuator 29 is driven in response to a drive signal from the BK ECU 25, the brake wheel cylinder may generate a braking force on each wheel to thereby perform forcible deceleration.

The traveling environment recognizing unit 11 may be fixed to an upper middle portion of a frontal interior of the vehicle. The traveling environment recognizing unit 11 may include an in-vehicle camera (stereo camera) including a main camera 11a and a sub-camera 11b, an image processing unit (IPU) 11c, and a traveling environment detector 11d.

The main camera 11a and the sub-camera 11b may be autonomous sensors that sense the actual space surrounding the vehicle. For example, the main camera 11a and the sub-camera 11b may be disposed laterally symmetrically about a middle portion in a width direction of the vehicle and may capture an environment in front of the vehicle from different line of sights.

The IPU 11c may generate a distance image by calculating a positional shift amount of a target object, based on a pair of stereo images of the environment in front of the own vehicle captured by the main camera 11a and the sub-camera 11b.

The traveling environment detector 11d may determine lane dividing lines that divide the road around the own vehicle into lanes, based on the distance image received from the IPU11c, for example. The traveling environment detector 11d may further determine a road curvature (1/m) of each lane dividing line that divides the traveling road on which the own vehicle travels (hereinafter referred to as traveling lane) into right and left lanes, and the width between the right and left lane dividing lines (i.e., a vehicle width), for example. The traveling environment detector 11d may further perform predetermined image processing such as pattern matching on the distance image to thereby detect lane lines and three-dimensional objects such as structures present in the vicinity of the vehicle.

Here, in the detection of the three-dimensional object performed by the traveling environment detector 11d, a kind of the three-dimensional object, a distance to the three-dimensional object, a speed of the three-dimensional object, and a relative speed between the three-dimensional object and the vehicle (own vehicle) may be detected, for example. Non-limiting examples of the three-dimensional object to be detected may include a traffic light, an intersection, a road sign, a stop line, another vehicle, and a pedestrian. The traveling environment detector 11d may output data on the detected three-dimensional object to the traveling ECU 22, for example.

The locator unit 12 may estimate a position of the vehicle (an own vehicle position) on a road map and may include a locator calculator 13 that estimates the own vehicle position. The locator calculator 13 may have an input side to which sensors necessary to estimate the position of the vehicle (own vehicle position) are coupled. Non-limiting examples of these sensors may include an acceleration sensor 14, a vehicle speed sensor 15, a gyroscope sensor 16, and a GNSS receiver 17. The acceleration sensor 14 may detect a longitudinal acceleration rate of the vehicle. The vehicle speed sensor 15 may detect a speed of the vehicle. The gyroscope sensor 16 may detect an angular velocity or an angular acceleration of the vehicle. The GNSS receiver 17 may receive positional signals transmitted from a plurality of positioning satellites. Further, a transceiver 18 may be coupled to the locator calculator 13. The locator calculator 13 may transmit and receive information to/from the control apparatus 200 and transmit and receive information to/from another vehicle.

A high-precision road map database 19 may be coupled to the locator calculator 13. The high-precision road map database 19 may be a mass storage medium such as an HDD and hold high-precision road map data (a dynamic map). Like the road map data included in the road map data integration ECU 201, the high-precision road map data may include road data and traffic data, for example. The road data may include static data and quasi-static data, and the traffic data may include quasi-dynamic data and dynamic data.

The locator calculator 13 may include, for example, a map data acquirer 13a, a vehicle position estimator 13b, and a traveling environment recognizer 13c.

The vehicle position estimator 13b may acquire position coordinates of the vehicle (own vehicle), based on the positioning signals received at the GNSS receiver 17. Further, the vehicle position estimator 13b may estimate the own vehicle position on the road map by performing map matching of the acquired position coordinates to the route map data. Based on the position coordinates of the vehicle (own vehicle) acquired by the vehicle position estimator 13b, the map data acquirer 13a may acquire map data covering a predetermined area including the own vehicle position from the map data held in the high-precision road map database 19.

In an environment such as inside a tunnel where it is difficult to acquire effective positional signals from the positioning satellites due to a low sensitivity of the GNSS receiver 17, the vehicle position estimator 13b may estimate the own vehicle position on the road map by switching the method of estimating the own vehicle position on the road map to an autonomous navigation method of estimating the own vehicle position on the road map, based on the vehicle speed detected by the vehicle speed sensor 15, the angular velocity detected by the gyroscope sensor 16, and the longitudinal acceleration rate detected by the acceleration sensor 14.

When detecting the position of the vehicle (own vehicle position) on the road map, based on the positioning signals received at the GNSS receiver 17 or the information detected by the gyroscope sensor 16 as described above, for example, the vehicle position estimator 13b may determine a road type of the traveling toad on which the own vehicle is traveling, based on the estimated own vehicle position on the road map.

Using the road map data acquired through external communication (e.g., road-to-vehicle communication and vehicle-to-vehicle communication) via the transceiver 18, the traveling environment recognizer 13c may update the road map data held in the high-precision road map database 19 to the latest state. The update may be applied to the static data and also to the quasi-static data, the quasi-dynamic data, and the dynamic data. The road map data may thus include the road data and traffic data acquired by the communication with the outside of the vehicle, and the data on a mobile body such as a vehicle traveling on the road may be updated in substantially real time.

Based on the traveling environment information recognized by the traveling environment recognizing unit 11, the traveling environment recognizer 13c may verify the road map data and update the road map data held in the high-precision road map database 19 to the latest state. The update may be applied to the static data and also to the quasi-static data, the quasi-dynamic data, and the dynamic data. The data on a mobile body such as a vehicle traveling on the road recognized by the traveling environment recognizing unit 11 may be thereby updated in real time.

The road map data updated as described above may be sent to the control apparatus 200 and the other vehicles present around the own vehicle through the road-to-vehicle communication and the vehicle-to-vehicle communication via the transceiver 18. Further, the traveling environment recognizer 13c may output the map data covering the predetermined area including the own vehicle position estimated by the vehicle position estimator 13b, out of the updated road map data, together with the own vehicle position (vehicle position data) to the traveling ECU 22.

Next, the traveling ECU 22 will be described in detail.

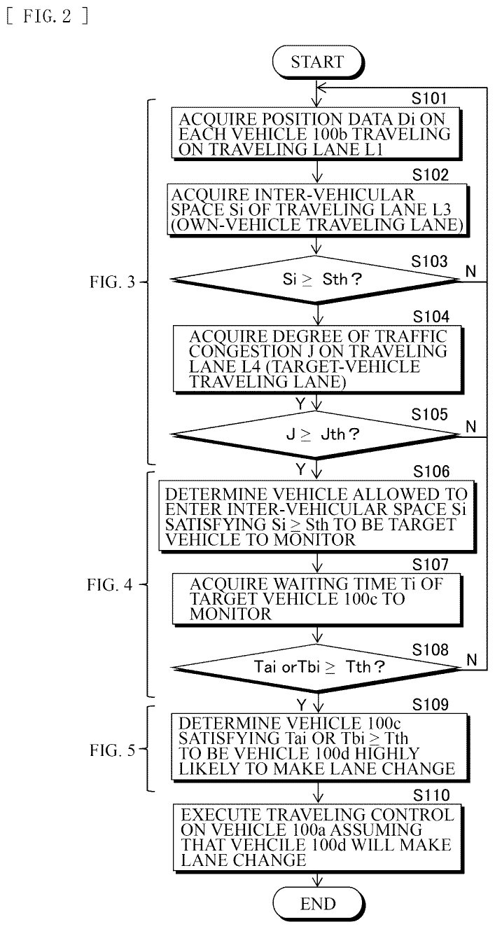

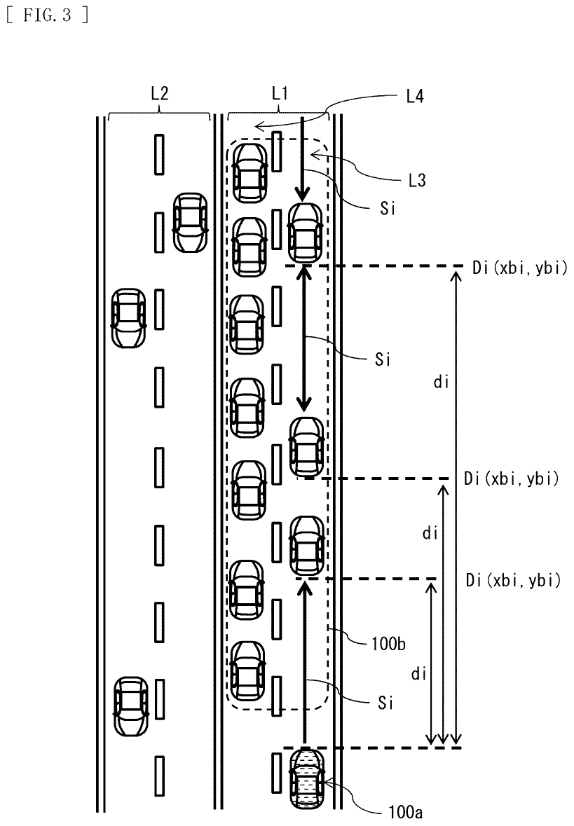

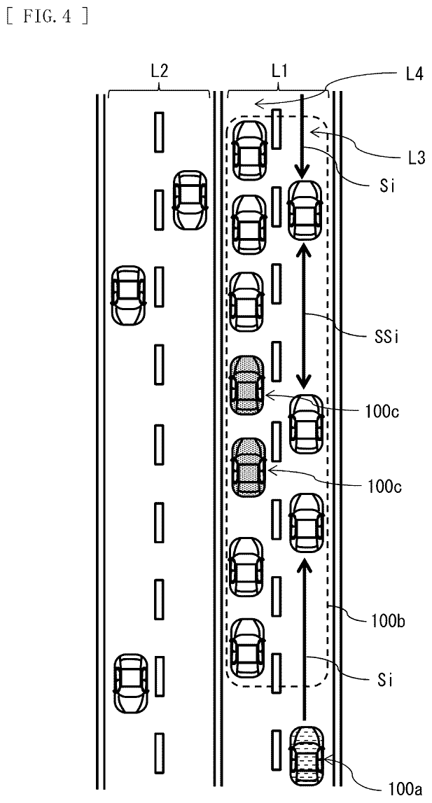

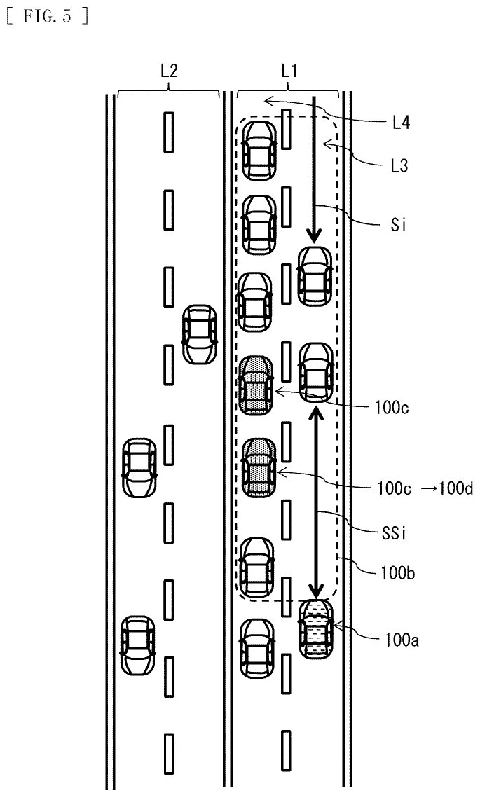

FIG. 2 illustrates an exemplary process performed by the traveling control system 1 to estimate a lane change. FIG. 3 illustrates an exemplary traffic situation in Steps S101 to S105 in FIG. 2. FIG. 4 illustrates an exemplary traffic situation in Steps S106 to S108 in FIG. 2. FIG. 5 illustrates an exemplary traffic situation in Step S109 in FIG. 2.

In FIG. 3, a vehicle (an own vehicle) 100a may travel on a road with two lanes each way. In one embodiment, the vehicle 100a may serve as a “first vehicle”. The road may include a traveling lane L1 on which the vehicle 100a travels, and an oncoming lane L2 provided along the traveling lane L1 with a center line provided therebetween. The traveling lane L1 may include two traveling lanes L3 and L4. In one embodiment, the traveling lane L3 may serve as a “first lane”. In one embodiment, the traveling lane L4 may serve as a “second lane”. The traveling lane L3 may be what is called a passing lane. The traveling lane L4 may be provided between the center line and the traveling lane L3. The vehicle 100a may travel on the traveling lane L3, and another vehicle which is predicted to make a lane change from the traveling lane L4 to the traveling lane L3 may travel on the traveling lane L4. There may be much traffic on the traveling lane L4, and a driver who drives the vehicle on the traveling lane L4 is in the psychological state of wanting to make a lane change from the traveling lane L4 to the traveling lane L3.

The stereo camera provided in the vehicle 100a may capture a stereo image of an environment in front of the vehicle 100a and output the stereo image to the IPU 11c. The stereo image may include at least vehicles traveling on the traveling lane L1 ahead of the vehicle 100a. At this time, the traveling environment detector 11d may directly detect an inter-vehicular space Si of the traveling lane L3. In some embodiments, the traveling ECU 22 may detect position data and length data on the inter-vehicular space Si, based on the inter-vehicular space Si detected by the traveling environment detector 11d, the map data and the own vehicle position received from the traveling environment recognizer 13c.

In a road condition where the inter-vehicular space Si is not visually recognizable, the traveling environment detector 11d may have a difficulty in detecting the inter-vehicular space Si in the stereo image. To address such a condition, the traveling ECU 22 may have a functionality of estimating the inter-vehicular space Si even when the data on the inter-vehicular space Si is not obtainable from the traveling environment detector 11d. In the following, an exemplary method of estimating the inter-vehicular space Si will be described.

First, the stereo camera may acquire a stereo image and output the stereo image to the IPU 11c. The IPU 11c may generate a distance image, based on the stereo image acquired by the stereo camera, and output the distance image to the traveling environment detector 11d. The traveling environment detector 11d may perform predetermined pattern matching on the distance image generated by the IPU 11c to detect each vehicle 100b traveling ahead of the vehicle 100a on the traveling lane L1. In one embodiment, vehicles traveling on the traveling lane L3 out of the vehicles 100b may serve as a “plurality of third vehicles”.

When each vehicle 100b is detected, the traveling environment detector 11d may calculate a distance di from the vehicle 100a to each vehicle 100b. In some embodiments, the traveling environment detector 11d may calculate the distance di from the vehicle 100a to each vehicle 100b, based on the distance image described above. The traveling environment detector 11d may associate the calculated distance di with an identifier of each vehicle 100b and output the resultant data to the traveling ECU 22.

The traveling ECU 22 may acquire the map data on the predetermined area including the own vehicle position estimated by the vehicle position estimator 13b and the own vehicle position from the traveling environment recognizer 13c. In one embodiment, the own vehicle position may serve as “first vehicle position data”. The traveling ECU 22 may perform matching of the vehicle 100b, based on the distance di and the identifier of the vehicle 100b received from the traveling environment detector 11d, and the map data and the own vehicle position acquired from the traveling environment recognizer 13c.

In some embodiments, the traveling ECU 22 may determine whether the map data acquired from the traveling environment recognizer 13c includes data related to the vehicle 100b detected by the traveling environment recognizer 13c. For example, the traveling ECU 22 may acquire, as the position of the vehicle 100b acquired by the stereo camera, a position (xbi, ybi) distant from the own vehicle position by the distance di, from the map data acquired from the traveling environment recognizer 13c. Here, “xbi” represents longitude data in the road map data held in the high-precision road map database 19, and “ybi” represents longitude data in the road map data held in the high-precision road map database 19.

Thereafter, the traveling ECU 22 may determine whether the data related to the vehicle 100b is included within a predetermined distance area (threshold) from the position (xbi, ybi) of the vehicle 100b, based on the map data acquired from the traveling environment recognizer 13c. When detecting the data relating to the vehicle 100b within the above-described area, based on the map data acquired from the traveling environment recognizer 13c, for example, the traveling ECU 22 may acquire a position (Xbi, Xbi) as position data Di on the vehicle 100b (Step S101). In one embodiment, the position data on the vehicle 100b traveling on the traveling lane L3 out of the position data Di may serve as “third vehicle position information”.

When the matching of the vehicle 100b has been successfully performed, the traveling ECU 22 may acquire the inter-vehicular space Si between two vehicles 100b adjacent to each other on the traveling lane L3, based on the map data acquired from the traveling environment recognizer 13c (Step S102). In some embodiments, the traveling ECU 22 may calculate the inter-vehicular space Si, using the positions (Xbi, Xbi) of the two vehicles 100b adjacent to each other.

When the matching of the vehicle 100b has not been successfully performed, the traveling ECU 22 may determine whether the inter-vehicular space Si has been already calculated. When determining that the inter-vehicular space Si has been already calculated, the traveling ECU 22 may determine the inter-vehicular space Si having been calculated as a current inter-vehicular space Si. When determining that the inter-vehicular space Si has not been calculated, the traveling ECU 22 may end the calculation of the inter-vehicular space Si.

Thereafter, the traveling ECU 22 may determine whether the inter-vehicular space Si is greater than or equal to a threshold Sth (Step S103). When determining that the inter-vehicular space Si is less than the threshold Sth (Step S103: N), the traveling ECU 22 may execute Step S101 again. In contrast, when determining that the inter-vehicular space Si is greater than or equal to the threshold Sth (Step S103: Y), the traveling ECU 22 may acquire a degree of congestion J on the traveling lane L4, based on the position data Di on each vehicle 100b traveling on the traveling lane L4 (Step S104). In some embodiments, the traveling ECU 22 may calculate the degree of congestion J on the traveling lane L4 by dividing the number of vehicles 100b present on the traveling lane L4 and within a range from the vehicle (own vehicle) 100a to a position ahead of and distant from the vehicle (own vehicle) 100a by a predetermined distance (a distance Do) by the distance Do.

Thereafter, the traveling ECU 22 may determine whether the degree of congestion J is greater than or equal to a threshold Jth (Step S105). When determining that the degree of congestion J is less than the threshold Jth (Step S105: N), the traveling ECU 22 may execute Step S101 again. In contrast, when the degree of congestion J is greater than or equal to the threshold Jth (Step S105: Y), the traveling ECU 22 may determine the vehicle 100b that is allowed to enter the inter-vehicular space Si satisfying Si≥Sth (an entry available space SSi) to be a target vehicle 100c to monitor, as illustrated in FIG. 4 (Step S106). In one embodiment, the entry available space SSi may serve as an “entry available space”. In one embodiment, the target vehicle 100c may serve as a “second vehicle”.

As described above, the traveling ECU 22 may determine whether the inter-vehicular space Si is the entry available space SSi, based on the position data on the vehicle (own vehicle) 100a, the position data Di on each vehicle 100b, and size data on the inter-vehicular space Si. When determining that the inter-vehicular space Si is the entry available space SSi, the traveling ECU 22 may execute the following process.

Based on data acquired through the repeated execution of each process described above (e.g., Steps S101 to S106), for example, the traveling ECU 22 may estimate a waiting time Tai of the target vehicle 100c or measure a measurement time Tbi having a predetermined correlation with the waiting time Tai (Step S107). The waiting time Tai may correspond to a waiting time estimated to be spent by the target vehicle 100c before starting to make a lane change to the entry available space SSi. When the target vehicle 100c continues to travel on the traveling lane L4 without making a lane change to the entry available space SSi, the waiting time Tai may correspond to a waiting time estimated to be spent by the vehicle 100c before starting to make a lane change to the entry available space SSi appearing next. In some embodiments, the waiting time Tai may be estimated, based on a distance between the target vehicle 100c and the entry available space SSi, a speed of the target vehicle 100c, and a speed of the vehicle 100b at a front end of the entry available space SSi.

Start timings of the waiting time Tai and the measurement time Tbi may include various timings, as described below, for example. In Case A where the vehicle 100c refrains from making a lane change to the traveling lane L3 despite that the inter-vehicular space Si is the entry available space SSi to which the target vehicle 100c is allowed to make a lane change before the determination at Step S103 is executed, the start timings of the waiting time Tai and the measurement time Tbi may each correspond to a timing of the occurrence of Case A, for example. In one embodiment, the vehicle 100b at the rear end of the entry available space SSi may serve as a “fourth vehicle”. In Case B where the target vehicle 100c encounters traffic congestion on the traveling lane L4 before the determination at Step S103 is executed, the start timings of the waiting time Tai and the measurement time Tbi may each correspond to a timing of the occurrence of Case B, for example.

In some embodiments, an end timing of the measurement time Tbi may be a start timing of the determination at Step S108. The start timing of the determination at Step S108 may be a timing a predetermined time before a timing at which the target vehicle 100c actually makes a lane change. The end timing of the measurement time Tbi is not limited to the start timing of the determination at Step S108.

Thereafter, the traveling ECU 22 may estimate the likelihood of the target vehicle 100c entering the entry available space SSi, based on the waiting time Tai or the measurement time Tbi. In some embodiments, the traveling ECU 22 may determine whether the waiting time Tai or the measurement time Tbi is greater than or equal to the threshold Tth (Step S108). When determining that the waiting time Tai or the measurement time Tbi is less than the threshold Tth (Step S108: N), the traveling ECU 22 may execute Step S101 again. In contrast, when determining that the waiting time Tai or the measurement time Tbi is greater than or equal to the threshold Tth (Step S108: Y), the traveling ECU 22 may determine the vehicle 100c satisfying Tai≥Tth or Tbi≥Tth to be a vehicle 100d highly likely to make a lane change (Step S109), as illustrated in FIG. 5, for example.

Thereafter, the traveling control apparatus 10 of the vehicle (own vehicle) 100a may execute the traveling control assuming that the vehicle 100d will make a lane change (Step S110). As described above, the traveling control system 1 may estimate the occurrence of a lane change and execute the traveling control.

### Effects

Some effects of the traveling control system 1 according to the example embodiment will now be described.

In the present embodiment, when the inter-vehicular space Si is the entry available space SSi, the likelihood of the target vehicle 100c entering the entry available space SSi may be estimated, based on the length of the waiting time Tai spent by the target vehicle 100c before the start of the lane change to the entry available space SSi or the length of the measurement time Tbi.

In this example, the driver who drives the target vehicle 100c may continuously pay attention to the traveling lane L3 to look out for the entry available space SSi during the waiting time Ti. Thus, as the waiting time Tai is prolonged, the driver who drives the target vehicle 100c may get more irritated and pay less attention to the surrounding traffic situation. As a result, the driver who drives the vehicle 100c may become prone to make recognition mistakes, and reflexively make a lane change to the inter-vehicular space Sb upon finding out the inter-vehicular space Sb. Thus, as the waiting time Tai or the measurement time Tbi is prolonged, the likelihood of the target vehicle 100c making a lane change may become greater.

In the present embodiment, the likelihood of the target vehicle 100c entering the entry available space SSi is estimated based on the length of the waiting time Tai or the length of the measurement time Tbi highly correlated with the psychological state of the driver of the target vehicle 100c prone to make recognition mistakes as described above. It is therefore possible to reduce the possibility of frequent execution of unnecessary traveling control against lane changes.

In the present embodiment, the start timing of the waiting time Tai or the start timing of the measurement time Tbi may correspond to the timing of occurrence of Case A as described above. In Case A, the driver of the target vehicle 100c having failed to make a lane change may be in a psychological state of wanting to make a lane change at an early timing, that is, in the psychological state prone to make recognition mistakes. Accordingly, the estimation of the waiting time Tai or the measurement of the measurement time Tbi may be started at the timing of occurrence of Case A, and the likelihood of the target vehicle 100c entering the entry available space SSi may be estimated based on the waiting time Tai thus estimated or the measurement time Tbi thus measured. It is therefore possible to reduce the possibility of frequent execution of unnecessary traveling control against lane changes.

In the present embodiment, the start timing of the waiting time Tai or the start timing of the measurement time Tbi may correspond to the timing of occurrence of Case B as described above. In Case B, the driver of the target vehicle 100c may get irritated and be in the psychological state of wanting to make a lane change at an early timing. The driver may be thus in the psychological state prone to make recognition mistakes. Accordingly, the estimation of the waiting time Tai or the measurement of the measurement time Tbi may be started at the timing of occurrence of Case B, and the likelihood of the target vehicle 100c entering the entry available space SSi may be estimated based on the waiting time Tai thus estimated or the measurement time Tbi thus measured. It is therefore possible to reduce the possibility of frequent execution of unnecessary traveling control against lane changes.

### 3. Modification Example

Although the disclosure has been described by way of some example embodiments, the disclosure is not limited to the example embodiments, and various modification may be made.

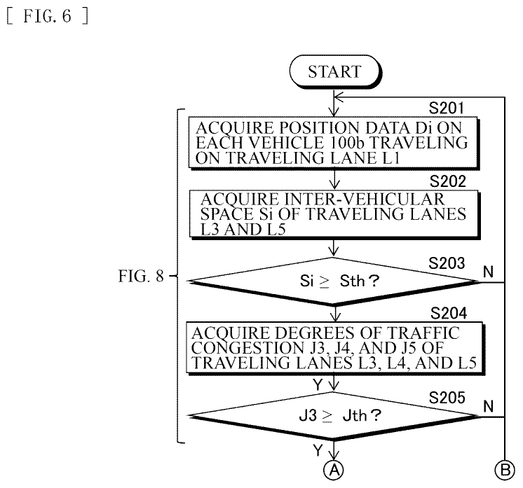

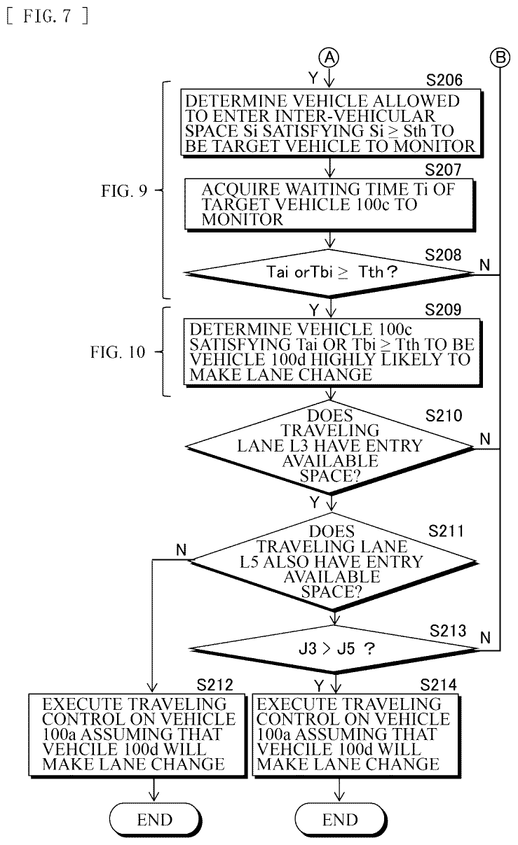

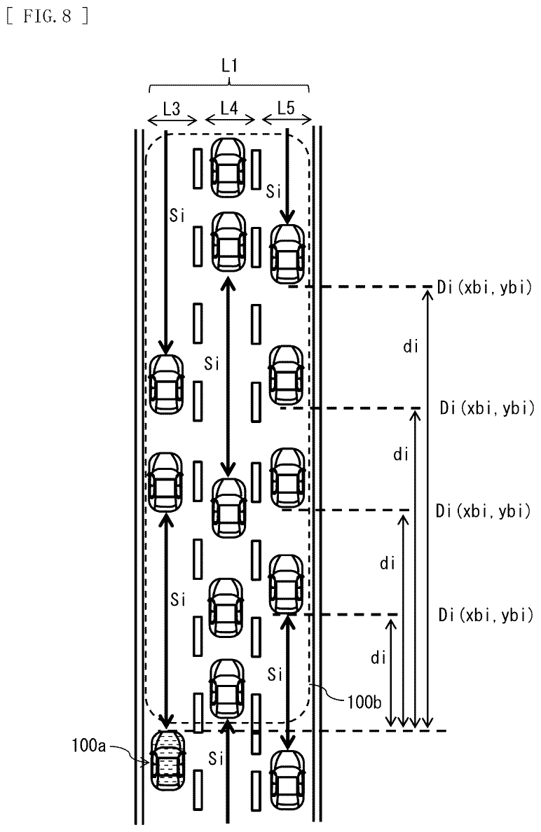

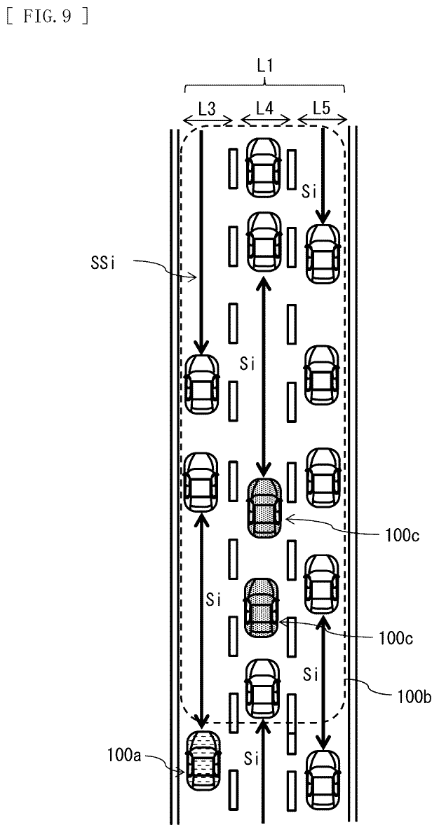

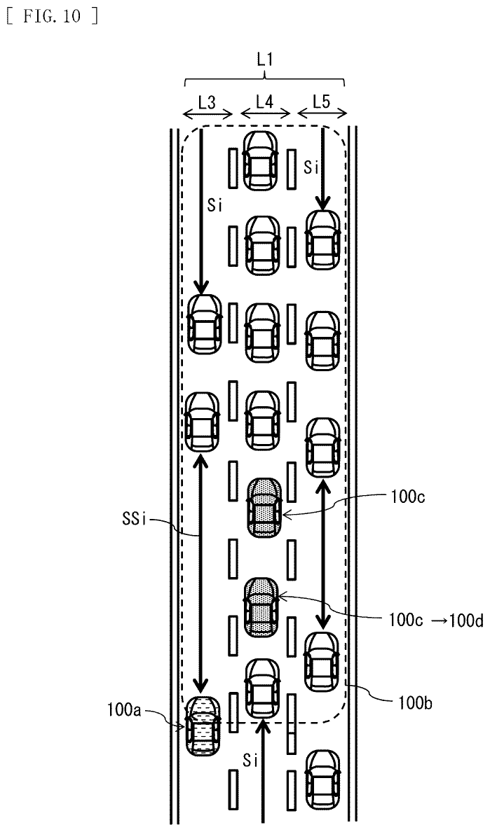

FIG. 6 illustrates a modification example of the process performed by the traveling control system 1 to estimate a lane change. FIG. 7 illustrates an exemplary estimation process subsequent to FIG. 6. FIG. 8 illustrates an exemplary traffic situation in Steps S201 to S205 in FIG. 6. FIG. 9 illustrates an exemplary traffic situation in Steps S206 to S208 in FIG. 7. FIG. 10 illustrates an exemplary traffic situation in Step S209 in FIG. 7.

In FIG. 8, the vehicle (own vehicle) 100a may travel on a road with three lanes each way. The road may include a traveling lane L1 on which the vehicle 100a travels, and a non-illustrated oncoming lane provided along the traveling lane L1 with a center line provided therebetween. The traveling lane L1 may include three traveling lanes L3, L4, and L5 having the same traveling direction. The traveling lanes L4 and L5 may be each what is called a passing lane. The traveling lane L4 may be a center lane, and the traveling lane L3 may be provided between the center line and the traveling lane L4. In one embodiment, the traveling lane L3 may serve as a “left-side lane”. In one embodiment, the traveling lane L5 may serve as a “right-side lane”.

The vehicle 100a may travel on the traveling lane L3, and another vehicle which will make a lane change from the traveling lane L4 to the traveling lane L3 or the traveling lane L5 may travel on the traveling lane L4. There may be much traffic on the traveling lane L4, and a driver who drives the vehicle traveling on the traveling lane L4 may be in the psychological state of wanting to make a lane change from the traveling lane L4 to the traveling lane L3 or the traveling lane L5.

The stereo camera provided in the vehicle 100a may capture a stereo image of an environment in front of the vehicle 100a and output the stereo image to the IPU11c. The stereo image may include at least vehicles traveling on the traveling lane L1 ahead of the vehicle 100a. At this time, the traveling environment detector 11d may directly detect inter-vehicular spaces Si of the traveling lanes L3, L4, and L5. In some embodiments, the traveling ECU 22 may detect position data and length data on the inter-vehicular spaces Si, based on the inter-vehicular spaces Si detected by the traveling environment detector 11d, the map data and the own vehicle position received from the traveling environment recognizer 13c.

In a road condition where the inter-vehicular space Si is not visually recognizable, the traveling environment detector 11d may have a difficulty in detecting the inter-vehicular space Si in the stereo image. To address such a condition, the traveling ECU 22 may have the functionality of estimating the inter-vehicular space Si even when the data on the inter-vehicular space Si is not obtainable from the traveling environment detector 11d. In the following, an exemplary method of estimating the inter-vehicular space Si will be described.

First, the stereo camera may acquire a stereo image and output the stereo image to the IPU 11c. The IPU 11c may generate a distance image, based on the stereo image acquired by the stereo camera, and output the distance image to the traveling environment detector 11d. The traveling environment detector 11d may perform predetermined pattern matching on the distance image generated by the IPU 11c to detect each vehicle 100b traveling ahead of the vehicle 100a on the traveling lane L1.

When each vehicle 100b is detected, the traveling environment detector 11d may calculate a distance di from the vehicle 100a to each vehicle 100b. In some embodiments, the traveling environment detector 11d may calculate the distance di from the vehicle 100a to each vehicle 100b, based on the distance image described above. The traveling environment detector 11d may associate the calculated distance di with an identifier of each vehicle 100b and output the resultant data to the traveling ECU 22.

The traveling ECU 22 may acquire the map data on the predetermined area including the own vehicle position estimated by the vehicle position estimator 13b and the own vehicle position from the traveling environment recognizer 13c. The traveling ECU 22 may perform matching of the vehicle 100b, based on the distance di and the identifier of the vehicle 100b received from the traveling environment detector 11d, and the map data and the own vehicle position acquired from the traveling environment recognizer 13c.

In some embodiments, the traveling ECU 22 may determine whether the map data acquired from the traveling environment recognizer 13c includes data related to the vehicle 100b detected by the traveling environment recognizer 13c. For example, the traveling ECU 22 may acquire, as the position of the vehicle 100b acquired by the stereo camera, a position (xbi, ybi) distant from the own vehicle position by the distance di, from the map data acquired from the traveling environment recognizer 13c.

Thereafter, the traveling ECU 22 may determine whether the data related to the vehicle 100b is included within a predetermined distance area (threshold) from the position (xbi, ybi) of the vehicle 100b, based on the map data acquired from the traveling environment recognizer 13c. When detecting the data relating to the vehicle 100b within the above-described area, based on the map data acquired from the traveling environment recognizer 13c, for example, the traveling ECU 22 may acquire a position (Xbi, Xbi) as position data Di on the vehicle 100b (Step S201).

When the matching of the vehicle 100b has been successfully performed, the traveling ECU 22 may acquire the inter-vehicular space Si between two vehicles 100b adjacent to each other on the traveling lane L3 or L5, based on the map data acquired from the traveling environment recognizer 13c (Step S202). In some embodiments, the traveling ECU 22 may calculate the inter-vehicular space Si, using the positions (Xbi, Xbi) of the two vehicles 100b adjacent to each other.

When the matching of the vehicle 100b has not been successfully performed, the traveling ECU 22 may determine whether the inter-vehicular space Si has been already calculated. When determining that the inter-vehicular space Si has been already calculated, the traveling ECU 22 may determine the inter-vehicular space Si having been calculated as a current inter-vehicular space Si. When determining that the inter-vehicular space Si has not been calculated, the traveling ECU 22 may end the calculation of the inter-vehicular space Si.

Thereafter, the traveling ECU 22 may determine whether the inter-vehicular space Si is greater than or equal to a threshold Sth (Step S203). When determining that the inter-vehicular space Si is less than the threshold Sth (Step S203: N), the traveling ECU 22 may execute Step S201 again. In contrast, when determining that the inter-vehicular space Si is greater than or equal to the threshold Sth (Step S203: Y), the traveling ECU 22 may acquire degrees of congestion J3, J4, and J5 (data on the number of vehicles 100b) on the traveling lane L1, based on the position data Di on each vehicle 100b traveling on the traveling lanes L3, L4, and L5 (Step S204).

In some embodiments, the traveling ECU 22 may calculate the degree of congestion J3 on the traveling lane L3 by dividing the number of vehicles 100b present on the traveling lane L3 and within a range from the vehicle (own vehicle) 100a to a position ahead of and distant from the vehicle (own vehicle) 100a by a predetermined distance (distance Do) by the distance Do. In some embodiments, the traveling ECU 22 may calculate the degree of congestion J4 of the traveling lane L4 by dividing the number of vehicles 100b present on the traveling lane L4 and within the range from the vehicle (own vehicle) 100a to the position ahead of and distant from the vehicle (own vehicle) 100a by the predetermined distance (distance Do) by the distance Do. In some embodiments, the traveling ECU 22 may calculate the degree of congestion J5 on the traveling lane L5 by dividing the number of vehicles 100b present on the traveling lane L5 and within the range from the vehicle (own vehicle) 100a to the position ahead of and distant from the vehicle (own vehicle) 100a by the predetermined distance (distance Do) by the distance Do.

Note that, after the target vehicle 100c to monitor is identified, the traveling ECU 22 may acquire the degree of congestion J3 or J5 (the data on the number of vehicles 100b), based on the position data Di on each vehicle 100b traveling ahead of the target vehicle 100c on the traveling lane L3 or L5 of the traveling lane L1.

Thereafter, the traveling ECU 22 may determine whether the degree of congestion J3 is greater than or equal to a threshold Jth (Step S205). When determining that the degree of congestion J3 is less than the threshold Jth (Step S205: N), the traveling ECU 22 may execute Step S201 again. In contrast, when the degree of congestion J3 is greater than or equal to the threshold Jth (Step S205: Y), the traveling ECU 22 may determine the vehicle 100b that is traveling on the traveling lane L4 and allowed to enter the inter-vehicular space Si of the traveling lane L3 or L5 satisfying Si≥Sth (i.e., the entry available space SSi) to be the target vehicle 100c to monitor, as illustrated in FIG. 9 (Step S206).

Note that the traveling ECU 22 may use the number of the vehicles 100b traveling ahead of the target vehicle 100c on the traveling lane L3, instead of the degree of congestion J3, and may use the number of vehicles 100b traveling ahead of the target vehicle 100c on the traveling lane L5, instead of the degree of congestion J5.

As described above, the traveling ECU 22 may determine whether the inter-vehicular space Si is the entry available space SSi, based on the position data on the vehicle (own vehicle) 100a, the position data Di on each vehicle 100b, and size data on the inter-vehicular space Si. When determining that the inter-vehicular space Si is the entry available space SSi, the traveling ECU 22 may execute the following process.

Based on data acquired through the repeated execution of each process described above (e.g., Steps S201 to S206), for example, the traveling ECU 22 may estimate a waiting time Tai of the target vehicle 100c or measure a measurement time Tbi having a predetermined correlation with the waiting time Tai (Step S207). The waiting time Tai may correspond to a waiting time estimated to be spent by the target vehicle 100c before starting to make a lane change to the entry available space SSi on the traveling lane L3 or L5. When the target vehicle 100c continues to travel on the traveling lane L4 without making a lane change to the entry available space SSi, the waiting time Tai may correspond to a waiting time estimated to be spent by the vehicle 100c before starting to make a lane change to the entry available space SSi on the traveling lane L3 or L5 appearing next. In some embodiments, the waiting time Tai may be estimated, based on a distance between the target vehicle 100c and the entry available space SSi, a speed of the target vehicle 100c, and a speed of the vehicle 100b at a front end of the entry available space SSi.

Start timings of the waiting time Tai and the measurement time Tbi may include various timings, as described below, for example. In Case A where the vehicle 100c refrains from making a lane change to the traveling lane L3 or L5 despite that the inter-vehicular space Si is the entry available space SSi to which the target vehicle 100c is allowed to make a lane change before the determination at Step S203 is executed, the start timings of the waiting time Tai and the measurement time Tbi may each correspond to a timing of the occurrence of Case A, for example. In Case B where the target vehicle 100c encounters traffic congestion on the traveling lane L4 before the determination at Step S203 is executed, the start timings of the waiting time Tai and the measurement time Tbi may each correspond to a timing of the occurrence of Case B, for example.

In some embodiments, an end timing of the measurement time Tbi may be a start timing of the determination at Step S208. The start timing of the determination at Step S208 may be a timing a predetermined time before a timing at which the target vehicle 100c actually makes a lane change. The end timing of the measurement time Tbi is not limited to the start timing of the determination at Step S208.

Thereafter, the traveling ECU 22 may estimate the likelihood of the target vehicle 100c entering the entry available space SSi, based on the waiting time Tai or the measurement time Tbi. In some embodiments, the traveling ECU 22 may determine whether the waiting time Tai or the measurement time Tbi is greater than or equal to the threshold Tth (Step S208). When determining that the waiting time Tai or the measurement time Tbi is less than the threshold Tth (Step S208: N), the traveling ECU 22 may execute Step S201 again. In contrast, when determining that the waiting time Tai or the measurement time Tbi is greater than or equal to the threshold Tth (Step S208: Y), the traveling ECU 22 may determine the vehicle 100c satisfying Tai≥Tth or Tbi≥Tth to be a vehicle 100d highly likely to make a lane change (Step S209), as illustrated in FIG. 10, for example.

Thereafter, the traveling ECU 22 may determine whether the traveling lane L3 has the entry available space SSi (Step S210). When determining that the traveling lane L3 has no entry available space SSi (Step S210: N), the traveling ECU 22 may execute Step S201 again. In contrast, when determining that the traveling lane L3 has the entry available space SSi (Step S210: Y), the traveling ECU 22 may determine whether the traveling lane L5 also has the entry available space SSi (Step S211). When determining that the traveling lane L5 has no entry available space SSi (Step S211: N), the traveling control apparatus 10 of the vehicle (own vehicle) 100a may execute the traveling control assuming that the vehicle 100d will make a lane change (Step S212).

In contrast, when determining that the traveling lane L5 also has the entry available space SSi (Step S211: Y), the traveling ECU 22 may determine whether the degree of congestion J3 is greater than the degree of congestion J5 (Step S213). When the degree of congestion J3 is less than or equal to the degree of congestion J5 (Step S212; N), the traveling ECU 22 may execute Step S201 again. In contrast, when the degree of congestion J3 is greater than the degree of congestion J5 (Step S212: N), the traveling control apparatus 10 of the vehicle (own vehicle) 100a may execute the traveling control assuming that the vehicle 100d will make a lane change (Step S214). As described above, the traveling control system 1 may estimate the lane change and execute the traveling control.

In the present modification example, the degree of congestion J3 or J5 on the traveling lane L4 (the data on the number of vehicles 100b) may be acquired based on the position data Di on each vehicle 100b traveling on the traveling lane L3 or L5. Thereafter, based on the degree of congestion J3 or J5 acquired as described above, the likelihood of the target vehicle 100c entering the entry available space SSi of the traveling lane L3 may be estimated.

During the waiting time Ti, the driver who drives the target vehicle 100c may intend to make a lane change to either the traveling lane L3 or L5, whichever is less congested, taking into consideration the degree of congestion J3 or J5 ahead of the vehicle 100c. Thus, when the degree of congestion J3 on the traveling lane L3 is less than the degree of congestion J5 on the traveling lane L5, that is, when the traveling lane L3 has more spaces available for a lane change than the traveling lane L5 does, the target vehicle 100c is likely to enter the entry available space SSi of the traveling lane L3.

As described above, in the present modification example, the likelihood of the target vehicle 100c entering the entry available space SSi may be estimated based on the degrees of congestions J3 and J5 on the traveling lanes L3 and L5 ahead of the vehicle 100c to which the driver who drives the target vehicle 100c pay attention to make a lane change. It is therefore possible to reduce the possibility of frequent execution of unnecessary traveling control against lane changes.

In the present modification example, when the inter-vehicular space Si is the entry available space SSi, the likelihood of the vehicle 100c entering the entry available space SSi may be estimated based on the length of the waiting time Ti estimated to be spent by the target vehicle 100c before starting to make a lane change to the entry available space SSi, and the length of the measurement time Tbi having the predetermined correlation with the waiting time Tai.

In this example, the driver who drives the target vehicle 100c may continuously pay attention to the traveling lane L3 to look out for the entry available space SSi during the waiting time Ti. Thus, as the waiting time Tai is prolonged, the driver who drives the target vehicle 100c may get more irritated and pay less attention to the surrounding traffic situation. As a result, the driver who drives the vehicle 100c may become prone to make recognition mistakes, and reflexively make a lane change to the inter-vehicular space Sb upon finding out the inter-vehicular space Sb. Thus, as the waiting time Tai or the measurement time Tbi is prolonged, the likelihood of the target vehicle 100c making a lane change may become greater.

In the present embodiment, the likelihood of the target vehicle 100c entering the entry available space SSi is estimated based on the length of the waiting time Tai or the length of the measurement time Tbi highly correlated with the psychological state of the driver of the target vehicle 100c prone to make recognition mistakes as described above. It is therefore possible to reduce the possibility of frequent execution of unnecessary traveling control against lane changes.

Although some embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof. Further, the effects described herein are mere example and non-limiting. The disclosure may have effects other than the effects described herein.

Further, the disclosure may have the following configurations, for example.
(1) A driver assistance apparatus including
   a processor configured to estimate a likelihood of a second vehicle entering an inter-vehicular space ahead of a first vehicle traveling on a first lane by making a lane change from a second lane adjacent to the first lane, in which
   the processor is configured to
   acquire position data on each of third vehicles traveling on the first lane and size data on the inter-vehicular space ahead of the first vehicle, the third vehicles including the first vehicle,
   make a determination, based on the position data and the size data, as to whether the inter-vehicular space is an entry available space which the second vehicle is allowed to enter by making the lane change, and
   estimate, when the inter-vehicular space is the entry available space, a likelihood of the second vehicle entering the entry available space, based on a length of a waiting time estimated to be spent by the second vehicle before starting to make the lane change to the entry available space or a length of a measurement time having a predetermined correlation with the length of the waiting time.
(2) The driver assistance apparatus according to (1), in which,
   in a case where the second vehicle refrains from making a lane change despite that an inter-vehicular space ahead of a fourth vehicle traveling on the first lane is the entry available space before the determination is made, a start timing of the waiting time or a start timing of the measurement time corresponds to a timing of occurrence of the case.
(3) The driver assistance apparatus according to (1), in which,
   in a case where the second vehicle encounters traffic congestion on the second lane before the determination is made, a start timing of the waiting time or a start timing of the measurement time corresponds to a timing of occurrence of the case.
(4) A vehicle including
   a processor configured to estimate a likelihood of a second vehicle entering an inter-vehicular space ahead of a first vehicle traveling on a first lane by making a lane change from a second lane adjacent to the first lane, in which
   the processor is configured to
   acquire position data on each of third vehicles traveling on the first lane and size data on the inter-vehicular space ahead of the first vehicle, the third vehicles including the first vehicle,
   make a determination, based on the position data and the size data, as to whether the inter-vehicular space is an entry available space which the second vehicle is allowed to enter by making the lane change, and
   estimate, when the inter-vehicular space is the entry available space, a likelihood of the second vehicle entering the entry available space, based on a length of a waiting time estimated to be spent by the second vehicle before starting to make the lane change to the entry available space or a length of a measurement time having a predetermined correlation with the length of the waiting time.
(5) A driver assistance method of estimating a likelihood of a second vehicle entering an inter-vehicular space ahead of a first vehicle traveling on a first lane by making a lane change from a second lane adjacent to the first lane, the method including:
   acquiring, with integrated circuitry, position data on each of third vehicles traveling on the first lane and size data on the inter-vehicular space ahead of the first vehicle via a communication line, the third vehicles including the first vehicle;
   determining, with the integrated circuitry, whether the inter-vehicular space is an entry available space which the second vehicle is allowed to enter by making the lane change, based on the position data and the size data; and
   when the inter-vehicular space is the entry available space, estimating, with the integrated circuitry, a likelihood of the second vehicle entering the entry available space, based on a length of a waiting time estimated to be spent by the second vehicle before starting to make the lane change to the entry available space or a length of a measurement time having a predetermined correlation with the length of the waiting time.
(6) A driver assistance apparatus including
   a processor configured to
      estimate a likelihood of a first vehicle entering a right-side lane or a left-side lane by making a lane change from a center lane, and
      estimate a likelihood of the first vehicle entering an inter-vehicular space ahead of a third vehicle traveling on the right-side lane or the left-side lane by making a lane change from the center lane, the center lane, the right-side lane, and the left-side lane having respective traveling directions identical to each other, in which
   the processor is configured to
   acquire data on number of a second vehicle traveling ahead of the first vehicle on the right-side lane or the left-side lane,
   estimate a likelihood of the first vehicle entering the right-side lane or the left-side lane, based on the data on the number of the second vehicle,
   acquire position data on each of fourth vehicles traveling on the right-side lane or the left-side lane on which the third vehicle travels, and size data on the inter-vehicular space ahead of the third vehicle the fourth vehicles including the third vehicle,
   make a determination, based on the position data and the size data, as to whether the inter-vehicular space is an entry available space which the second vehicle is allowed to enter by making a lane change, and
   estimate, when the inter-vehicular space is the entry available space, a likelihood of the second vehicle entering the entry available space, based on a length of a waiting time estimated to be spent by the second vehicle before starting to make the lane change to the entry available space or a length of a measurement time having a predetermined correlation with the length of the waiting time.
(7) The driver assistance apparatus according to (6), in which
   the processor is configured to compare the number of the second vehicle traveling ahead of the first vehicle on the right-side lane with the number of the second vehicle traveling ahead of the first vehicle on the left-side lane, and
   estimate that the first vehicle is likely to make a lane change to either the right-side lane or the left-side lane, whichever is smaller in the number of the second vehicle.

The traveling control apparatus 10 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the traveling control apparatus 10 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the traveling control apparatus 10 illustrated in FIG. 1.

1. A driver assistance apparatus comprising
a processor configured to estimate a likelihood of a second vehicle entering an inter-vehicular space ahead of a first vehicle traveling on a first lane by making a lane change from a second lane adjacent to the first lane, wherein
the processor is configured to
acquire position data on each of third vehicles traveling on the first lane and size data on the inter-vehicular space ahead of the first vehicle, the third vehicles including the first vehicle,
make a determination, based on the position data and the size data, as to whether the inter-vehicular space is an entry available space which the second vehicle is allowed to enter by making the lane change, and
when the inter-vehicular space is the entry available space, estimate a likelihood of the second vehicle entering the entry available space, based on a length of a waiting time estimated to be spent by the second vehicle before starting to make the lane change to the entry available space or a length of a measurement time having a predetermined correlation with the length of the waiting time.

2. The driver assistance apparatus according to claim 1, wherein
in a case where the second vehicle refrains from making a lane change despite that an inter-vehicular space ahead of a fourth vehicle traveling on the first lane is the entry available space before the determination is made, a start timing of the waiting time or a start timing of the measurement time corresponds to a timing of occurrence of the case.

3. The driver assistance apparatus according to claim 1, wherein
in a case where the second vehicle encounters traffic congestion on the second lane before the determination is made, a start timing of the waiting time or a start timing of the measurement time corresponds to a timing of occurrence of the case.

4. A vehicle comprising
a processor configured to estimate a likelihood of a second vehicle entering an inter-vehicular space ahead of a first vehicle traveling on a first lane by making a lane change from a second lane adjacent to the first lane, wherein
the processor is configured to
acquire position data on each of third vehicles traveling on the first lane and size data on the inter-vehicular space ahead of the first vehicle, the third vehicles including the first vehicle,
make a determination, based on the position data and the size data, as to whether the inter-vehicular space is an entry available space which the second vehicle is allowed to enter by making the lane change, and
when the inter-vehicular space is the entry available space, estimate a likelihood of the second vehicle entering the entry available space, based on a length of a waiting time estimated to be spent by the second vehicle before starting to make the lane change to the entry available space or a length of a measurement time having a predetermined correlation with the length of the waiting time.

5. A driver assistance method of estimating a likelihood of a second vehicle entering an inter-vehicular space ahead of a first vehicle traveling on a first lane by making a lane change from a second lane adjacent to the first lane, the method comprising:
acquiring, with integrated circuitry, position data on each of third vehicles traveling on the first lane and size data on the inter-vehicular space ahead of the first vehicle via a communication line, the third vehicles including the first vehicle;
determining, with the integrated circuitry, whether the inter-vehicular space is an entry available space which the second vehicle is allowed to enter by making the lane change, based on the position data and the size data; and
when the inter-vehicular space is the entry available space, estimating, with the integrated circuitry, a likelihood of the second vehicle entering the entry available space, based on a length of a waiting time estimated to be spent by the second vehicle before starting to make the lane change to the entry available space or a length of a measurement time having a predetermined correlation with the length of the waiting time.

6. A driver assistance apparatus comprising
a processor configured to
estimate a likelihood of a first vehicle entering a right-side lane or a left-side lane by making a lane change from a center lane, and
estimate a likelihood of the first vehicle entering an inter-vehicular space ahead of a third vehicle traveling on the right-side lane or the left-side lane by making a lane change from the center lane, the center lane, the right-side lane, and the left-side lane having respective traveling directions identical to each other, wherein
the processor is configured to
acquire data on number of a second vehicle traveling ahead of the first vehicle on the right-side lane or the left-side lane,
estimate a likelihood of the first vehicle entering the right-side lane or the left-side lane, based on the data on the number of the second vehicle,
acquire position data on each of fourth vehicles traveling on the right-side lane or the left-side lane on which the third vehicle travels, and size data on the inter-vehicular space ahead of the third vehicle, the fourth vehicles including the third vehicle,
make a determination, based on the position data and the size data, as to whether the inter-vehicular space is an entry available space which the second vehicle is allowed to enter by making a lane change, and
when the inter-vehicular space is the entry available space, estimate a likelihood of the second vehicle entering the entry available space, based on a length of a waiting time estimated to be spent by the second vehicle before starting to make the lane change to the entry available space or a length of a measurement time having a predetermined correlation with the length of the waiting time.

7. The driver assistance apparatus according to claim 6, wherein
the processor is configured to compare the number of the second vehicle traveling ahead of the first vehicle on the right-side lane with the number of the second vehicle traveling ahead of the first vehicle on the left-side lane, and
estimate that the first vehicle is likely to make a lane change to either the right-side lane or the left-side lane, whichever is smaller in the number of the second vehicle.
